(19) United States
(12) Patent Application Publication
(10) Pub. No.: US 2015/0111643 A1
(43) Pub. Date: Apr. 23, 2015

(54) SYSTEMS AND METHODS FOR INTERACTIVE GAMEPLAY

(71) Applicant: KING.COM LIMITED, St. Julians (MT)

(72) Inventors: Jonas Olofsson, Bromma (SE); Patrik Stymne, Enskede (SE); Lars Sjodin, Farsta (SE); Sebastian Knutsson, Bromma (SE)

(21) Appl. No.: 14/402,831

(22) PCT Filed: May 23, 2013
(86) PCT No.: PCT/EP2013/060641

§ 371 Date: Nov. 21, 2014

Related U.S. Application Data
(63) Continuation-in-part of application No. 13/479,107, filed on May 23, 2012.
(60) Provisional application No. 61/701,907, filed on Sep. 17, 2012.

(30) Foreign Application Priority Data
Mar. 28, 2013 (GB) 1305767.4

(51) Int. Cl. A63F 13/35; A63F 13/49; A63F 13/79

(52) U.S. Cl. CPC A63F 13/35; A63F 13/79; A63F 13/49
USPC 463/31; 463/42

(57) ABSTRACT

A system for enabling interactive gameplay is disclosed, comprising: a first server configured to communicate with a first computing device using a first Application Programming Interface (API), wherein the first server comprises a first data store; a second server configured to communicate with a second computing device using a second API, wherein the second server comprises a second data store; and a third server for communicating with the first server and second server, wherein the third server comprises a third data store; wherein the first server, second server, and third server are configured to synchronize the first data store, second data store, and third data store to enable the first computing device and second computing device to engage in an interactive game.

### FIELD

The field of the invention relates to interactive game systems and methods that enable players to engage in a common interactive game, and to associated servers, devices and computer program products, and to uses thereof.

### BACKGROUND

Interactive video games among multiple players within a social network have become increasingly popular. For example, the assignee of this application is the creator of Bubble Witch Saga™, a popular game that can be played on facebook (registered trade mark: RTM). In Bubble Witch Saga, a particular player is faced with challenges of increasing difficulty. A player can engage in an interactive game with other users within his or her social network such that they can play the same Bubble Witch Saga game. When each player logs in to facebook and initiates the Bubble Witch Saga game, he or she will be provided with current information about the other players in the game, such as the status of each player (score, level, etc.), the names of players who are playing at the current time, and the names of players who have recently joined the game. The platform in this situation would be the facebook environment, where each player accesses the game using a web browser through facebook and the game is enabled by a server that communicates with each player's web browser using application programming interfaces (API's) in the facebook environment.

One limitation of the prior art systems is that players can only engage in a common interactive video game if they are using the same platform. At present, it is not possible to engage in a common interactive game from different platforms, such as the facebook environment and an ‘iOS’ environment (an operating system created and operated by Apple Inc. and used by mobile devices including iPhone® and iPad®) and Android® based environments used by other mobile devices. It also is not possible to engage in a common interactive game when a user does not have network connectivity.

What is needed is a gameplay system that can be accessed by users of different platforms. What is further needed is a gameplay system that allows play to continue even when a user has lost network connectivity and to synchronize once the user has regained network connectivity.

GB2454989B (see prior art FIG. 6) discloses that in an online game server 1, an updater updates at least one of a game program and game data for a server 1 stored in a storage section in accordance with an update operation for data to be utilized when a sub game other than a main game is executed on a client terminal 21-2N of an online game system. The updated data are stored in a shared library format that can be utilized in the client terminal 21-2N. A transmitter transmits the updated data including the updated portion data to the client terminal 21-2N. In the client terminal 21-2N, a rewriter rewrites at least one of a game program and game data for client stored in a memory. In the case where there is a specification operational input by a player, a controller controls progress of the sub game part of online game using the updated data stored within the client 21 2N without carrying out communication with the online game server 1. The sub game may be a tutorial mode for the online game that is normally executed using communication with the server 1. The online game therefore has online play and offline play, helping to reduce communication traffic load. Each of the online game server 1 and the plurality of client terminals 21 to 2N that constitute the online game system 4 is connected to a communication network 3 such as the Internet.

### SUMMARY OF THE INVENTION

According to a first aspect of the invention, there is provided a system for enabling interactive gameplay, comprising:

a first server configured to communicate with a first computing device using a first

Application Programming Interface (API), wherein the first server comprises a first data store;

a second server configured to communicate with a second computing device using a second API, wherein the second server comprises a second data store; and

a third server for communicating with the first server and second server, wherein the third server comprises a third data store;

wherein the first server, second server, and third server are configured to synchronize the first data store, second data store, and third data store to enable the first computing device and second computing device to engage in an interactive game.

The system may be one wherein the first API is a facebook API.

The system may be one wherein the second API is an Android API.

The system may be one wherein the second API is an iOS API.

The system may be one wherein the first computing device is a desktop computer.

The system may be one wherein the first computing device is a mobile device.

The system may be one wherein the third data store comprises a data structure for an interactive game.

The system may be one wherein the data structure comprises information for a plurality of players in the game.

According to a second aspect of the invention, there is provided a method of interactive gameplay, comprising:

displaying a game on a first computing device, wherein the first computing device comprises a first data store comprising a first data structure;

establishing communication between the first computing device and a first server using a first Application Programming Interface (API), wherein the first server comprises a first server data store comprising a first server data structure;

displaying a game on a second computing device, wherein the second computing device comprises a second data store comprising a second data structure;

establishing communication between the second computing device and a second server using a second API, wherein the second server comprises a second server data store comprising a second server data structure;

synchronizing the first data structure and the first server data structure using the first API;

synchronizing the first server data structure and the second server data structure; and

synchronizing the second server data structure and the second data structure using the second API.

The method may be one wherein the first API is a facebook API.

The method may be one wherein the second API is an Android API.

The method may be one wherein the second API is an iOS API.

The method may be one wherein the first computing device is a desktop computer.

The method may be one wherein the first computing device is a mobile device.

The method may be one wherein the step of synchronizing the first server data structure and the second server data structure is performed on a third server.

The method may be one wherein the third server comprises a master game data structure.

According to a third aspect of the invention, there is provided a multiplayer interactive game server system for playing a multiplayer interactive game, the system comprising:

a first server including a first data store relating to a state of the interactive game, the first server configured to communicate, using a first application programming interface, with a first plurality of devices of a first computing platform operable to participate in the interactive game;

a second server including a second data store relating to a state of the interactive game, the second server configured to communicate, using a second application programming interface different to the first application programming interface, with a second plurality of devices of a second computing platform, different to the first computing platform, operable to participate in the interactive game, and

a third server including a third data store relating to a state of the interactive game, the third server arranged to communicate with the first server and with the second server,

wherein the first, second and third servers are arranged to synchronize the first data store, the second data store and the third data store, such that when synchronized, the first data store, the second data store and the third data store all relate to a synchronized game state.

Further aspects of the third aspect of the invention are described in Claims 22 to 77.

An advantage is that because the first server is configured to communicate, using a first application programming interface, with a first plurality of devices of a first computing platform and the second server is configured to communicate, using a second application programming interface different to the first application programming interface, with a second plurality of devices of a second computing platform different to the first computing platform, the first and second servers can be maintained and upgraded separately without the complexities of maintaining them for communication with two different computing platforms. A further advantage is that because the first and second servers are dedicated to communication with different computing platforms, each can be more specialized and hence communicate more responsively with the devices with which they communicate. A further advantage is that game state synchronization can take place as a lower priority task than communicating with devices, so that communication with devices takes precedence when computational resources are in high demand, which improves the performance experienced by users of the devices communicating with the servers. A further advantage is that the system provides a multiuser interactive game across two different computer platforms. The system therefore has an improved architecture; there is an increase in the speed and reliability of the system, and the system operates in a new way.

According to a fourth aspect of the invention, there is provided a method of synchronizing a state of a multiplayer interactive game in a multiplayer interactive game server system, the system comprising:

a first server including a first data store relating to a state of the interactive game, the first server configured to communicate, using a first application programming interface, with a first plurality of devices of a first computing platform operable to participate in the interactive game;

a second server including a second data store relating to a state of the interactive game, the second server configured to communicate, using a second application programming interface different to the first application programming interface, with a second plurality of devices of a second computing platform different to the first computing platform operable to participate in the interactive game, and

a third server including a third data store relating to a state of the interactive game, the third server arranged to communicate with the first server and with the second server, the method comprising the steps of:

(i) synchronizing the first data store on the first server with the third data store on the third server,

(ii) synchronizing the second data store on the second server with the third data store on the third server, and

(iii) synchronizing the first data store on the first server with the third data store on the third server,

such that when synchronized, the first data store, the second data store and the third data store all relate to a synchronized game state.

Step (iii) ensures that data in the second data store relating to a synchronized game state is migrated to the first data store.

Further aspects of the fourth aspect of the invention are described in Claims 79 to 81.

An advantage is that because the first server is configured to communicate, using a first application programming interface, with a first plurality of devices of a first computing platform and the second server is configured to communicate, using a second application programming interface different to the first application programming interface, with a second plurality of devices of a second computing platform different to the first computing platform, the first and second servers can be maintained and upgraded separately without the complexities of maintaining them for communication with two different computing platforms. A further advantage is that because the first and second servers are dedicated to communication with different computing platforms, each can be more specialized and hence communicate more responsively with the devices with which they communicate. A further advantage is that game state synchronization can take place as a lower priority task than communicating with devices, so that communication with devices takes precedence when computational resources are in high demand, which improves the performance experienced by users of the devices communicating with the servers. The system therefore has an improved architecture; the method leads to an increase in the speed and reliability of the system and the method results in the system operating in a new way.

Use of a system or method according to any of the first, second, third or fourth aspects of the invention is provided.

According to a fifth aspect of the invention, there is provided a device in the first plurality of devices of a system according to the third aspect of the invention, the device configured to communicate with the first server, the device including an application operable to run the interactive game on the device, wherein the application is configured to create and to store on the device a data structure for a user of the device relating to a state of the interactive game.

Further aspects of the fifth aspect of the invention are described in Claims 83 to 95.

Further according to the fifth aspect of the invention, there is provided a computer program product embodied on a non-transient storage medium, the computer program product operable to execute on a device in the first plurality of devices of a system according to the third aspect of the invention, the device configured to communicate with the first server, the device including the computer program product operable to run the interactive game on the device, wherein the computer program product is configured to create and to store on the device a data structure for a user of the device relating to a state of the interactive game.

According to a sixth aspect of the invention, there is provided a multiplayer multiple interactive game server system comprising:

a first server including a first data store relating to states of a plurality of interactive games, the first server configured to communicate, using a first application programming interface, with a first plurality of devices of a first computing platform operable to participate in the plurality of interactive games;

a second server including a second data store relating to states of a plurality of interactive games, the second server configured to communicate, using a second application programming interface different to the first application programming interface, with a second plurality of devices of a second computing platform different to the first computing platform operable to participate in the plurality of interactive games, and

a third server including a third data store relating to states of the plurality of interactive games, the third server arranged to communicate with the first server and with the second server,

wherein the first, second and third servers are arranged to synchronize the first data store, the second data store and the third data store, such that when synchronized, the first data store, the second data store and the third data store all relate to synchronized states of the plurality of interactive games.

According to a seventh aspect of the invention, there is provided a method of synchronizing a state of a plurality of multiplayer interactive games in a multiplayer multiple interactive game server system comprising:

a first server including a first data store relating to states of the plurality of interactive games, the first server configured to communicate, using a first application programming interface, with a first plurality of devices of a first computing platform operable to participate in the plurality of interactive games;

a second server including a second data store relating to states of the plurality of interactive games, the second server configured to communicate, using a second application programming interface different to the first application programming interface, with a second plurality of devices of a second computing platform different to the first computing platform operable to participate in the plurality of interactive games, and

a third server including a third data store relating to states of the plurality of interactive games, the third server arranged to communicate with the first server and with the second server, the method comprising the steps of:

(i) synchronizing the first data store on the first server with the third data store on the third server,

(ii) synchronizing the second data store on the second server with the third data store on the third server, and

(iii) synchronizing the first data store on the first server with the third data store on the third server,

such that when synchronized, the first data store, the second data store and the third data store all relate to synchronized states of the plurality of interactive games.

According to an eighth aspect of the invention, there is provided a first server according to any of the first, second, third or fourth aspects of the invention. Use of such a first server is provided.

According to a ninth aspect of the invention, there is provided a second server according to any of the first, second, third or fourth aspects of the invention. Use of such a second server is provided.

According to a tenth aspect of the invention, there is provided a third server according to any of the first, third or fourth aspects of the invention. Use of such a third server is provided.

In this disclosure, a “server” should be construed broadly to include examples such as a single server in a single location, a group of servers in a single location, a group of servers over multiple locations, or a virtual server over many locations or in the Cloud, as would be clear to one skilled in the art.

### BRIEF DESCRIPTION OF THE DRAWINGS

The above and other aspects of the invention will now be described, by way of example only, with reference to the following Figures, in which:

FIG. 1 is a block diagram of a prior art interactive game system.

FIG. 2 illustrates an embodiment of a system that enables an interactive game by computing devices of different platforms.

FIG. 3 illustrates the embodiment for FIG. 2 with various data structures.

FIG. 4 illustrates an embodiment for creating a new interactive game session.

FIGS. 5A and 5B illustrate an embodiment for adding a new player to an interactive game.

FIG. 6 is a block diagram that shows an example of a configuration of an online game system according to prior art reference GB2454989B.

FIG. 7 is a Table showing examples of Fields and Sub-fields.

FIG. 8 shows an example of a path on a map, with each game level represented as a place on the path, with each user's current level in the game being represented by their place on the path.

FIG. 9 shows an example of a screen which provides a list of level numbers achieved by a user and friends.

FIG. 10 shows an example of an offer to receive a life sent by a friend.

FIG. 11 shows an example in which a user can buy a fixed number of new lives.

FIG. 12 shows an example in which it is possible to help a friend to unlock the next episode or game level.

FIG. 13 shows an example of a game-related newsfeed on Facebook.

FIG. 14 shows an example of a download link for a game application in a smartphone text message service.

FIG. 15A shows an example of a user being offered the option before starting to play the game of whether or not to connect to Facebook.

FIG. 15B shows an example of a user being offered the option before starting to play the game of whether or not to log out from Facebook.

### DETAILED DESCRIPTION

In examples, a method and apparatus are disclosed for enabling interactive gameplay across multiple platforms.

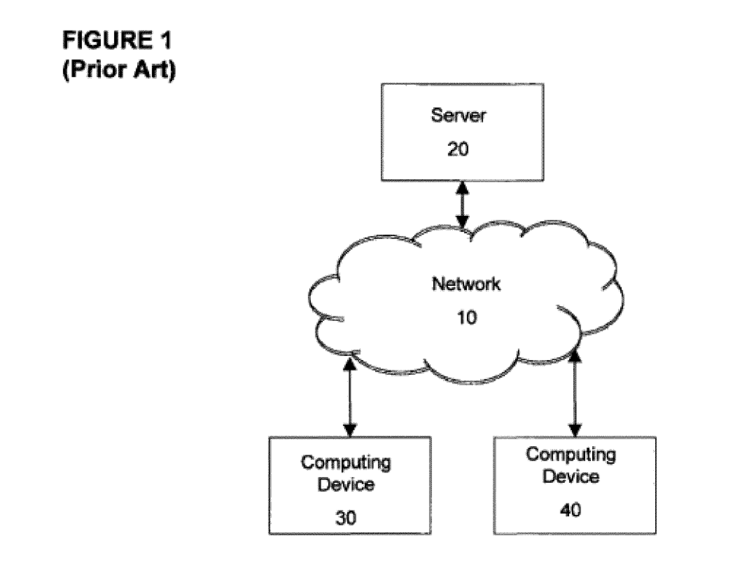

FIG. 1 depicts a prior art system in which exemplary computing devices 30 and 40 are coupled to server 20 across network 10. Computing devices 30 and 40 each can be a desktop, notebook, server, mobile device, or any other type of device with network connectivity. Network 10 can be a LAN, WAN, the Internet, or any other type of network. Computing devices 30 and 40 and server 20 each are coupled to network 10 using wired connections (such as Ethernet, DSL, cable modems, or other known wired connections) or wireless connections (such as 802.11, CDMA, EDGE, EV-DO, or other known wireless connections). Notably, in this prior art system, all communication between computing device 30, computing device 40, and server 20 occur using a common protocol, such as HTTP or an API.

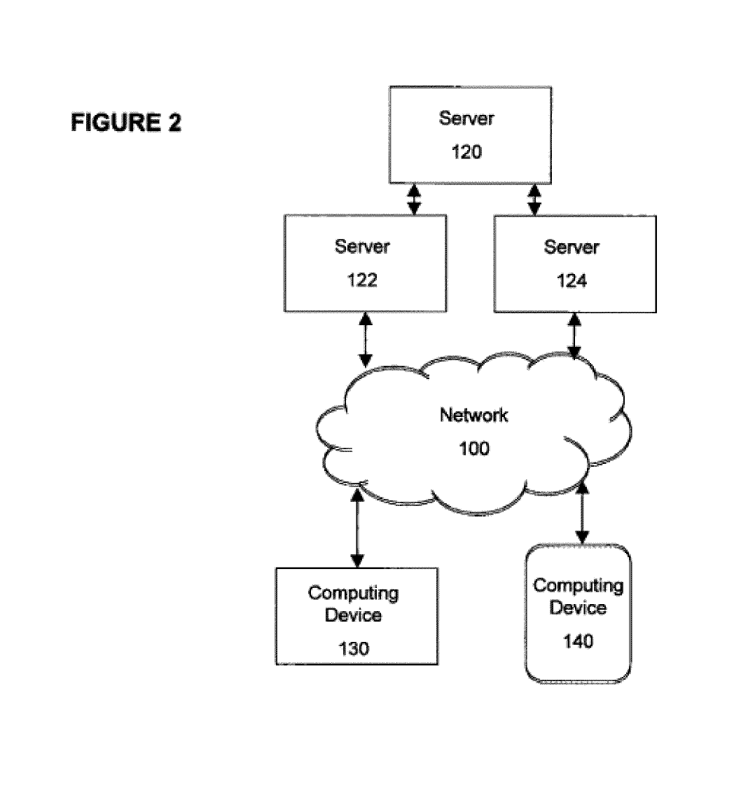

FIG. 2 depicts an embodiment of the present invention. Computing device 130 is coupled to server 122 over network 100. Computing device 140 is coupled to server 124 over network 100.

In this example, computing device 130 is a PC running a first platform, such as the facebook environment. Server 122 is configured to communicate with computing devices running the first platform, such as computing device 130. For example, server 122 can be configured to communicate using facebook APIs with computing devices running the first platform.

Computing device 140 is a mobile device running a second platform, such as an iPhone application or Android(RTM) application. Server 124 is configured to communicate with computing devices running the second platform, such as computing device 140. For example, server 124 can be configured to communicate using a proprietary API with computing devices using the second platform. Server 122 and server 124 are coupled to server 120.

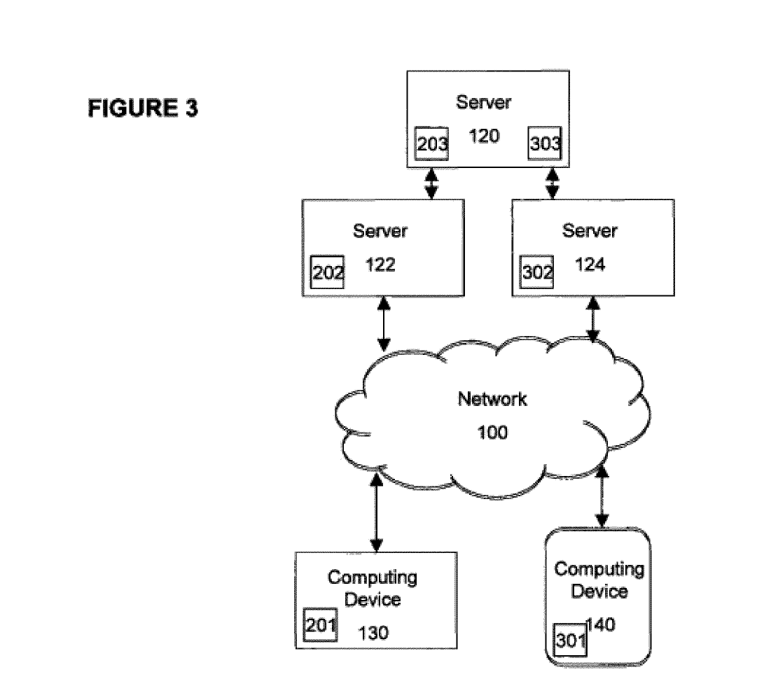

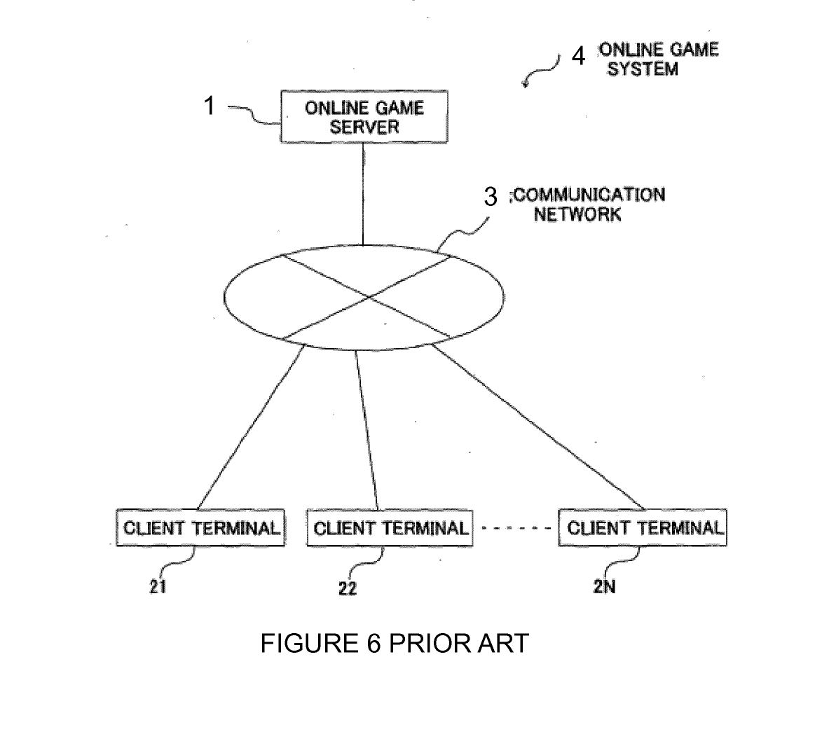

In this embodiment, User A (the user of computing device 130) and User B (the user of computing device 140) are able to play an interactive game together. With reference now to FIG. 3, the same structures from FIG. 2 are shown. Computing device 130 creates and stores data structure 201 for User A, and computing device 140 creates and stores data structure 301 for User B. Server 122 creates and stores data structure 202 for User A, and server 124 creates and stores data structure 302 for User B. Server 120 creates and stores data structure 203 for User A and data structure 303 for User B. Each of these data structures comprise common fields and sub-fields, such as for example the fields and sub-fields shown in the Table in FIG. 7.

Optionally, data structures 202, 203, 302, and 303 can be tables in a database, such as a MySQL database, wherein the key is the Data Structure ID, Game ID, or User ID. The database storing data structure 202 can run on server 122, the database storing data structure 302 can run on server 124, and the database or databases storing data structures 203 and 303 can run on server 120. Optionally, data structures 201 and 301 can be tables in databases running on computing device 130 and computing device 140, respectively.

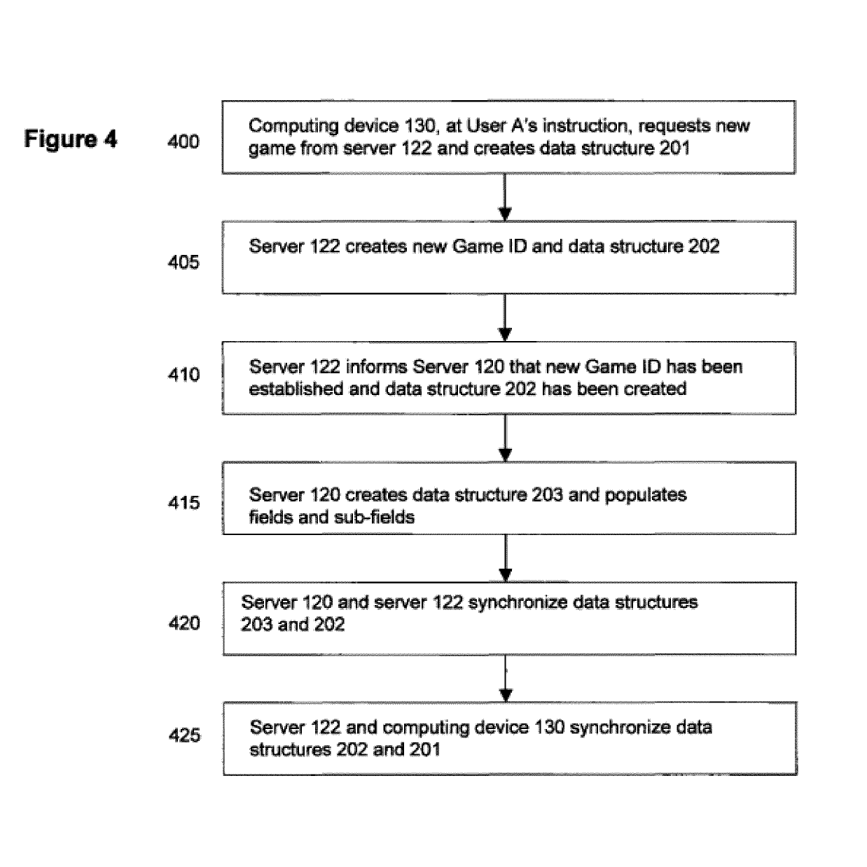

Referring now to FIG. 4, the initiation of an interactive game in an embodiment will now be discussed. In this example, computing device 130, at User A's instruction, requests a new game to be created by sending a message to server 122, and computing device 130 creates data structure 201 (step 400). Server 122 then creates a new Game ID and data structure 202 (step 405). Server 122 sends a message to server 120 that the new Game ID has been created and that data structure 202 has been created (step 410). Server 120 then creates data structure 203 and populates the fields and sub-fields (step 415). Server 120 and server 122 then synchronize data structure 203 and data structure 202 using the synchronization process described below (step 420). Server 122 and computing device 130 then synchronize data structure 202 and data structure 201 using the synchronization process described below (step 425).

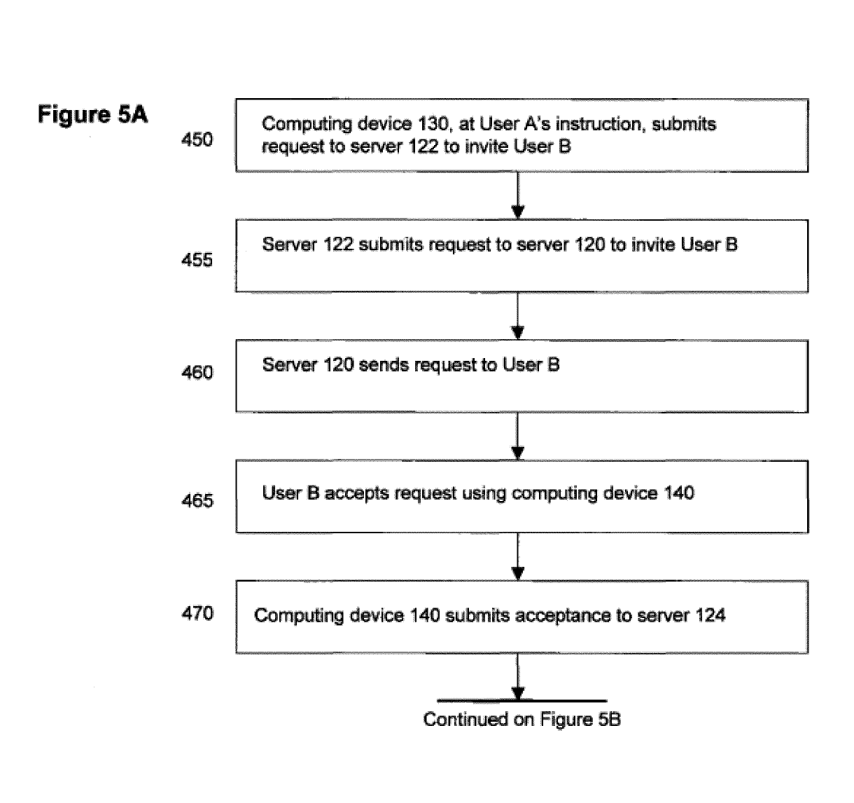

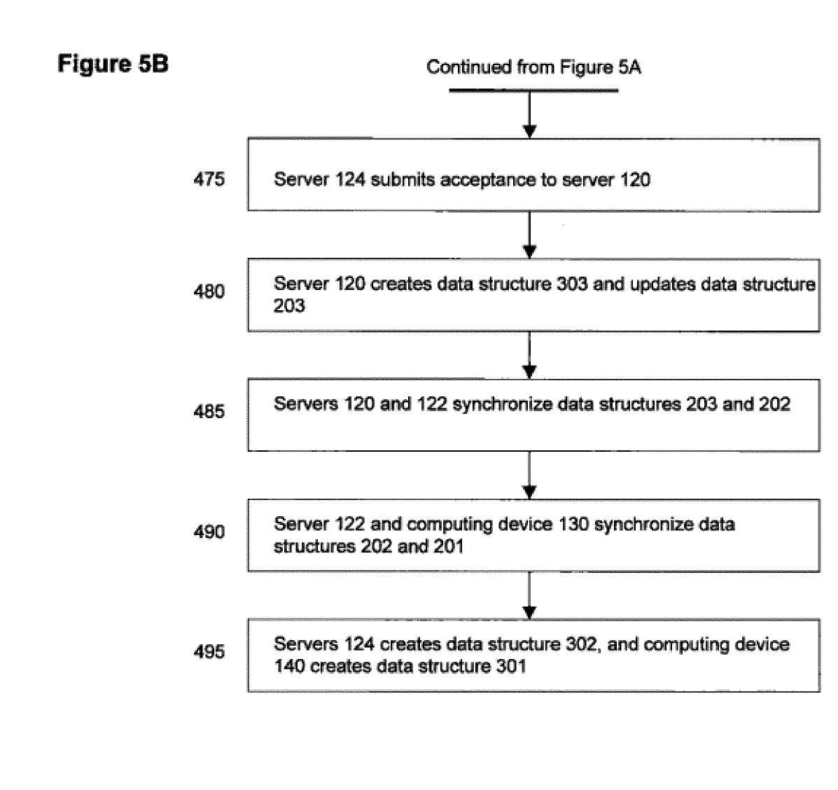

With reference now to FIGS. 5A and 5B, adding an additional player to the interactive game described previously with reference to FIG. 4 will now be discussed. In this example, computing device 130, at User A's instruction, submits a request to server 122 to invite User B to the interactive game (step 450). Server 122 submits the request to server 120 to invite User B (step 455). Server 120 then sends a request to User B to join the game (step 460). This request can be by email, SMS or MMS text message, an API sent directly to an application running on a computing device associated with User B, or another communication mechanism. User B then accepts the request using computing device 140 (step 465). The acceptance can be made by selecting a web link, responding by email, responding by SMS or MMS text message, selecting a button within an application, or any other communication mechanism. Computing device 140 transmits the acceptance to server 124 (step 470). Server 124 transmits the acceptance to server 120 (step 475). Server 120 creates data structure 303 and updates data structure 203 (step 480). Server 120 and server 122 synchronize data structures 203 and 202 (step 485). Server 122 and computing device 130 synchronize data structures 202 and 201 (step 490). Server 124 creates data structure 302 based on data structure 303, and computing device 140 creates data structure 301 based on data structure 302 (step 495).

In this example, server 122 communicates with computing device 130 using a first API (such as the facebook API), and server 124 communicates with computing device 140 using a second API (such as a proprietary API designed for use with an iPhone or Android device as the case may be). Server 122 and server 124 can communicate with server 120 using the first and second APIs, respectively, or using a third API or protocol (such as an API for inter-server communications).

An embodiment of a synchronization process will now be discussed. In the embodiments described thus far, data structures 201, 202, and 203 correspond to user A, and data structures 301, 302, and 303 correspond to User B. Optionally, server 120 can create and store a master game data structure 400 for the game that User A and User B have joined. Master game data structure 400 can contain the same fields and sub-fields describe previously for data structures 201, 202, 203, 301, 302, and 303.

During game play, User A will interact with computing device 130 and User B will interact with computing device 140. Computing device 130 runs local application 135 (not shown), and computing device 140 runs local application 145 (not shown). Local application 135 will update data structure 201 as User A progresses through the game. Local application 145 will update data structure 301 as User B progresses through the game. User A and User B need not necessarily be playing at the same time.

In the situation where User A is playing the game, periodically (such as once per minute in an example, or every 100 ms in another example) computing device 130 will send a synchronization request to server 122. The request will contain a timestamp. If that timestamp indicates a later time than the timestamp in data structure 202, then data structure 202 will be written over with the data from data structure 201 as to fields and sub-fields that have changed and the timestamp field of data structure 202 will be updated with the timestamp in the initial request from computing device 130. However, if the “Other Players” field and sub-field of data structures 201 and 202 do not match, then the “Other Players” field and sub-fields of data structure 201 will be overwritten with the data from data structure 202, because this mismatch would only occur if the status of other players had changed since the last synchronization event, in which case data structure 202 would contain the more recent data for the “Other Players.”

Periodically, server 122 will send a synchronization request to server 120. If the timestamp of data structure 202 indicates a later time than the timestamp in data structure 203, then data structure 203 will be written over with the data from data structure 202 as to fields and sub-fields that have changed and the timestamp field of data structure 203 will be updated with the timestamp of data structure 202. However, if the “Other Players” field and sub-field of data structures 202 and 203 do not match, then the “Other Players” field and sub-fields of data structure 202 will be overwritten with the data from data structure 203, because this mismatch would only occur if the status of other players had changed since the last synchronization event, in which case data structure 203 would contain the more recent data for the “Other Players.”

If the timestamp of data structure 203 indicates a later time than the timestamp in master game data structure 400, then master game data structure 400 will be written over with the data from data structure 203 as to fields and sub-fields that have changed and its timestamp field will be updated with the timestamp of data structure 203. However, if the “Other Players” field and sub-field of master game data structure 400 and data structure 203 do not match, then the “Other Players” field and sub-fields of data structure 203 will be overwritten with the data from master game data structure 400, because this mismatch would only occur if the status of other players had changed since the last synchronization event, in which case master game data structure 400 would contain the more recent data for the “Other Players.”

This synchronization process between computing device 130, server 122, and server 120 has been described thus far with reference to changes in the status of User A. It will be understood by one of ordinary skill in the art that the same changes could occur in data structures 301, 302, and 303 and master game data structure 400 with reference to changes in the status of User B.

The changes in data structures as to User A will now propagate to the data structures associated with User B. Periodically, server 120 will compare the timestamp fields of master game data structure 400 and data structure 303. If the timestamp of master game data structure 400 is a later time than that of data structure 303, then data structure 303 will be written over with the data from master game data structure 400 as to “Other Players” field and sub-fields that have changed and the time stamp of data structure 303 will be updated with the time stamp of data structure 400.

Periodically, server 120 will send a synchronization request to server 124. The request will contain the timestamp from data structure 303. If that timestamp indicates a later time than the timestamp in data structure 302, then data structure 302 will be written over with the data from data structure 303 as to the “Other Players” field and sub-fields that have changed.

Periodically, server 124 will send a synchronization request to computing device 140. The request will contain the timestamp from data structure 302. If that timestamp indicates a later time than the timestamp in data structure 301, then data structure 301 will be written over with the data from data structure 302 as to “Other Players” field and sub-fields that have changed.

Thus, it will be appreciated that User A and User B can engage in an interactive game through this synchronization process.

An embodiment enabling “airplane mode” will now be described. If User B loses connectivity to network 100 on computing device 140 (as might occur, for example, if computing device 140 is on an airplane or has lost WiFi or cellphone connectivity), then User B can continue to play the game on computing device 140 using local application 145. Local application 145 will continue to update data structure 301. When computing device 140 regains connectivity to network 100; computing device 140 will initiate the synchronization process described above. In this manner, User A will learn of the changes in User B's status even though the changes had occurred while User B was not connected to network 100.

The embodiments have been described as to two users, User A and User B, but it will be appreciated by one of ordinary skill in the art that the embodiments can accommodate any number of players. Similarly, the embodiments have been described as to two computing devices using two different platforms, computing device 130 and 140, but it will be appreciated by one of ordinary skill in the art that the embodiments can accommodate any number of computing devices utilizing any number of different platforms.

In addition, while the foregoing has been with reference to particular embodiments of the invention, it will be appreciated by those skilled in the art that changes in these embodiments may be made without departing from the principles and spirit of the invention, the scope of which is defined by the appended claims.

Building Multi-Platform Games

Three platforms in particular are changing the way people expect games to be played. These three platforms are growing at the same time, and provide new input possibilities. To date, games have not absorbed all the new input possibilities.

The first platform is Facebook. The skilled person will understand that where Facebook is referred to in this document, other social network platforms may be used. A Facebook game may be a social game, a game you play with your friends. It is rare or unthinkable to launch a game (i.e. to play for the first time) on Facebook that is a paid game, because people playing games on Facebook expect not to pay to access a game. A Facebook game may be played on the internet, after logging in to Facebook (whether automatically or manually), such as from a personal computer.

The second platform is smartphones. Use of smartphones is not always continuous. You may use a smartphone for 5 minutes on a bus, and then for 20 minutes on a connecting train, for example. The use can have many starts and stops. Not like someone working at an office desk or at a home desk in a conventional way. A smartphone can be on an iOS platform, or on an Android platform, for example.

The third platform is tablets. What is a tablet? It can function as a mobile device and as a non-mobile device. The tablet can be a substitute for a personal computer. A user may want a seamless experience between using the game on a personal computer and on a tablet and on another mobile device. A tablet can be on an iOS platform, or on an Android platform, for example.

A game which works on a plurality of such as all three of the above platforms (or more), may provide a connected fully-synchronized seamless experience. Hence multi-platform games are important. Key criteria for multi-platform games are: they are free, they are social, stop-start use is possible, and seamless experience is provided. Such games may be “played anywhere” e.g. in a mobile environment or in a non-mobile environment. Such games may also be played online or offline.

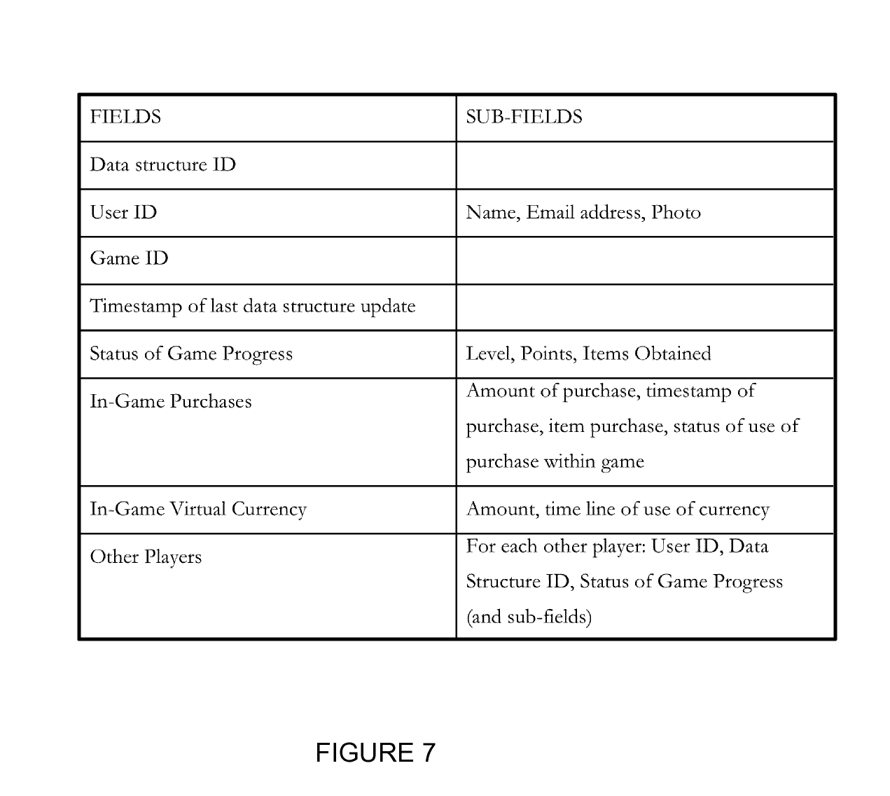

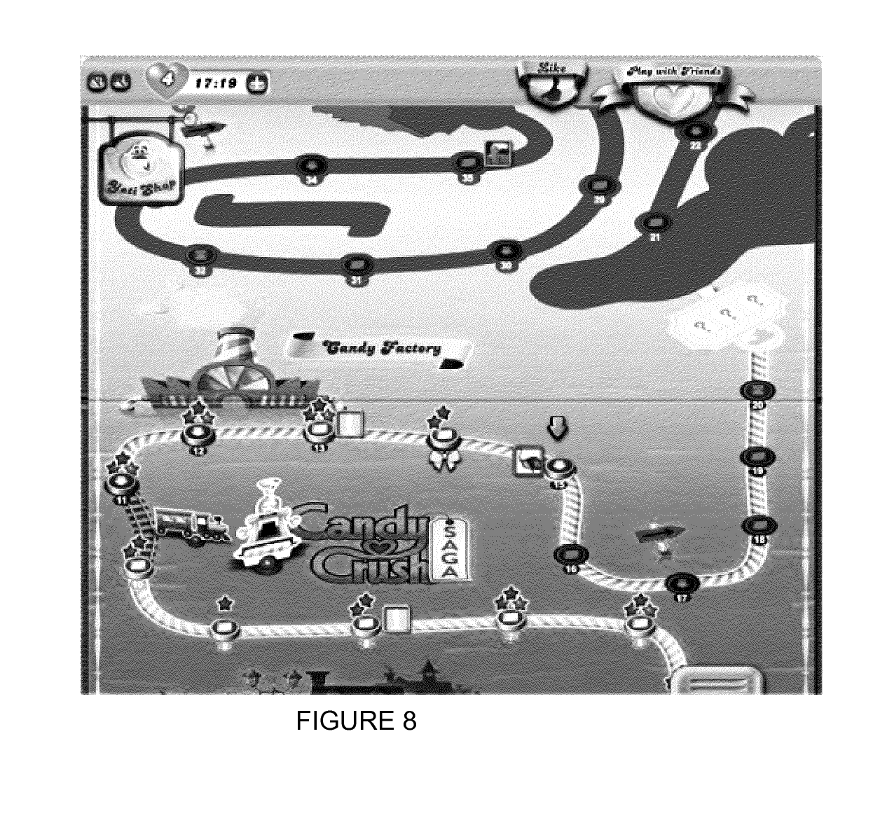

The game must be fun when used in a stop-start way, and when used for even just short intervals. In an example, a game consists of parts or levels, each of which runs for about 3 minutes, eg. between 1 and 5 minutes. In an example, a game is structured in levels, so that if successful in a game level, such as by scoring a minimum score, a user can progress from that level to the next level. In an example, a game has about 200 levels. A screen is provided on a device in which a user can see the level they have reached and the levels their friends have reached. The screen may show a path on a map, with each level represented as a place on the path, with each user's current level in the game being represented by their place on the path. An example is shown in FIG. 8. The position of a user or friend may include a representation which includes a photograph (such as the user's profile photo on Facebook). A screen may provide a list of level numbers achieved by the user and friends. An example is shown in FIG. 9. A screen may be provided which shows the scores achieved by the user and their friends on a given level, which may be restricted to the user's current level or to levels completed by the user.

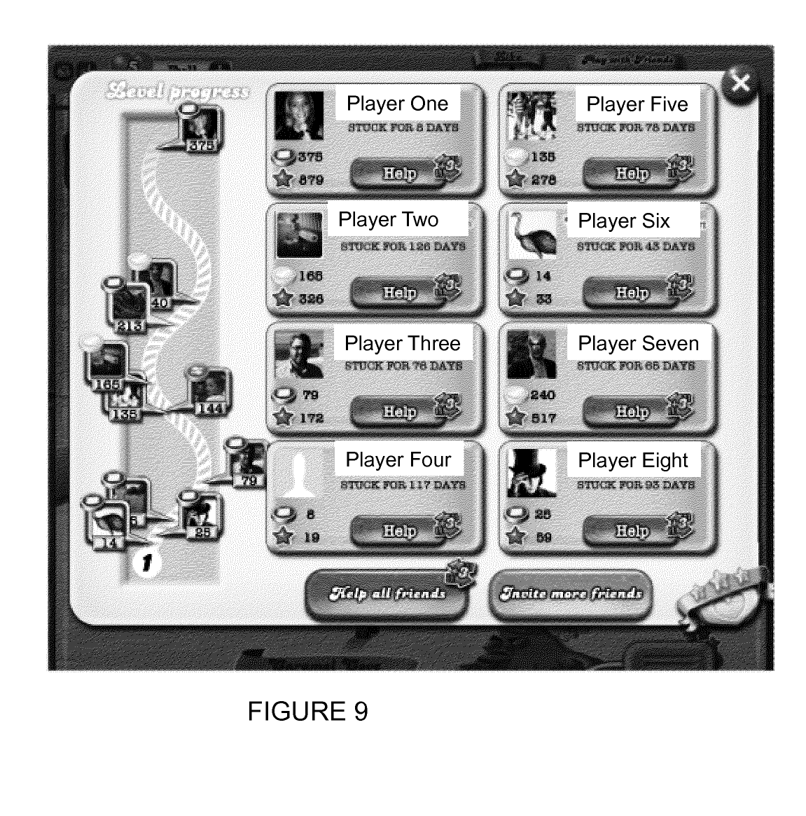

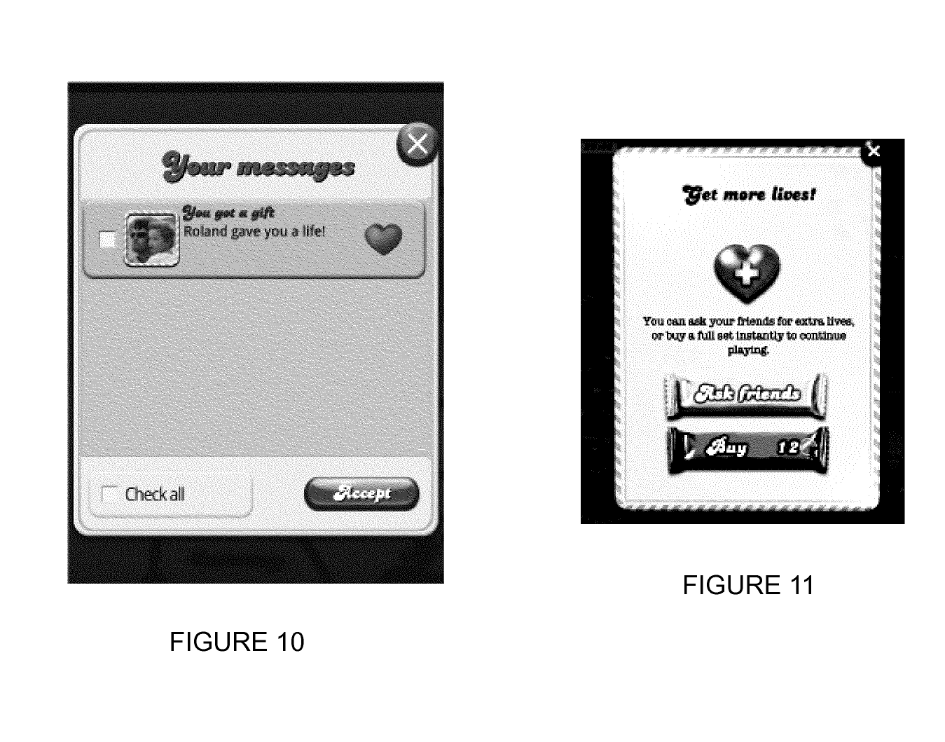

A business model is provided based on progressing between levels. Each user is provided with a starting number of lives in the game eg. five. If a user fails to make the minimum score or other target for the level, they lose a life. When they run out of lives, the following options may be provided. They can come back later (eg. in 30 minutes, or tomorrow) and get some new lives automatically. A new life may be provided automatically after a user has been playing the game for a particular time, eg. 30 minutes. They can invite friends and get new lives, for example if an invited friend joins the game. They can watch a commercial (eg. 15 seconds, or 30 seconds, in duration), or view an advertisement, and receive one or more new lives. They can ask their friends to send them lives. They can receive a life sent by a friend, with or without a request for a life having been sent to the friend. An example is shown in FIG. 10. They can buy a fixed number of new lives. An example is shown in FIG. 11. Or they can buy unlimited lives, which may be considerably more expensive.

A game can be optimized post-launch. For example, if it is clear that too many users are failing to progress past a particular level, the minimum score to pass the level can be lowered. An optimized game may be provided as an application update from an application store. In an alternative, a game may be optimized by a server sending a revised data file of scores required to pass each game level to a mobile device, when a game state of a user is being synchronized with the server, wherein the application running on the device replaces the previous file of scores stored on the device required to pass each level with the revised file of scores required to pass each level.

A game may be provided in which a criterion used to determine if a level of the game has been passed is changed if a user fails to pass the level after a predetermined number of attempts. For example, if an initial criterion is that a minimum score of 100 must be achieved for a user to pass a level, that criterion may be changed to a minimum score of 75 after a user has failed to pass the level ten times. In another example in a ball-moving game, a criterion could be changed from requiring four coloured balls in a row to requiring three coloured balls in a row, which is easier to achieve.

When inviting friends to a game (eg. through Facebook), a friend can receive the invite as a notification on his smartphone which is running a Facebook application. In the notification, a selectable icon or selectable item may be provided. Selecting the selectable icon or selectable item may lead the friend to an application store for the smartphone, to a download page for the application, from where the friend can download the game application. Later on, the friend can invite his friends to the game, which is a function included in the game application he downloaded.

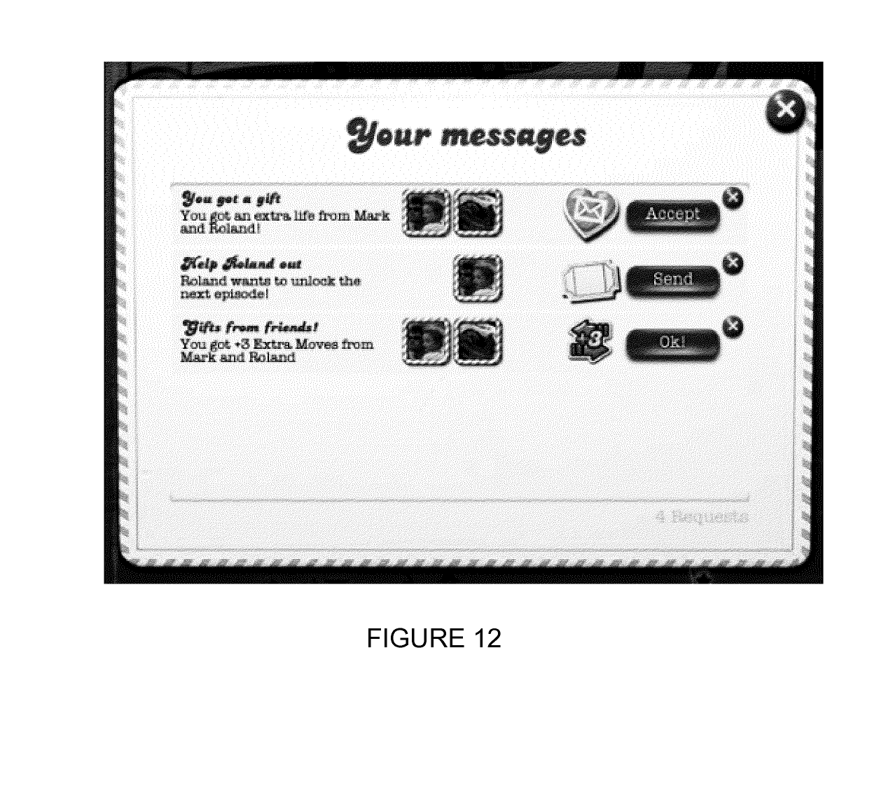

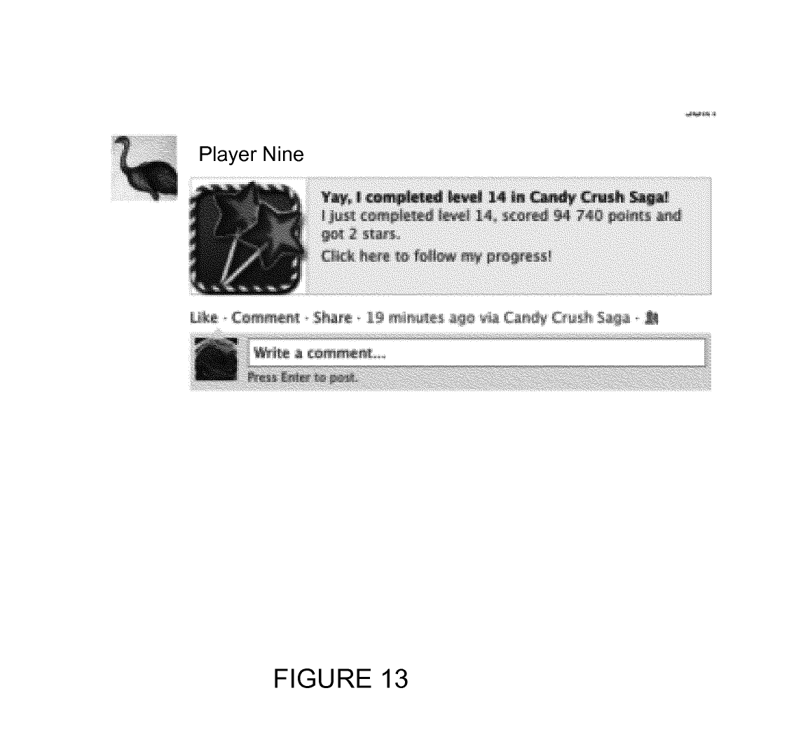

If a game is mobile-enabled, notifications (eg within the game application when it is running, eg. “Help Roland to unlock the next episode!”—see FIG. 12 for example), news feed (eg. from the game application to Facebook eg. a “Sandra has passed level 100 in Candy Crush Saga” to Sandra's newsfeed on Facebook. See FIG. 13 for an example.) and time line (eg. a chronology of game-related messages in Facebook eg. in an Activity Log), and bookmarks, will be sent to personal computers and to mobile devices.

Any user who is a player of a multi-platform game on Facebook on a non-mobile device, if they have a mobile device and they access Facebook on that mobile device, then they will see in Facebook on the mobile device a link to the game, which leads to the mobile device application store, to a screen from where the user can download the game for the mobile device.

A “send to mobile” function may be provided in Facebook on a non-mobile device, which is operable to send a download link for a game application to a smartphone eg.

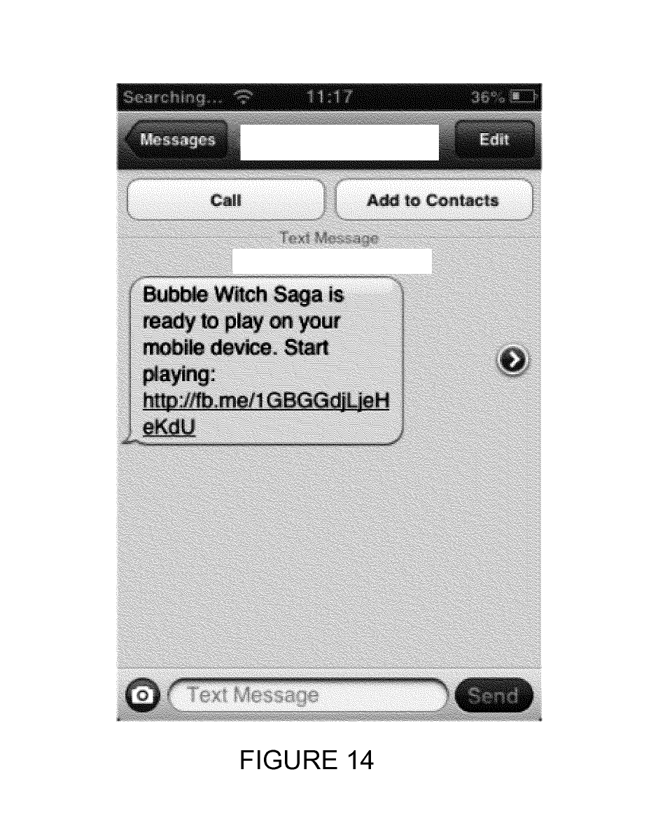

using a text message service such as short message service (SMS). See FIG. 14 for example.

There is synchronization of the multi-platform game state across platforms. So for example, if a user is at a given level (eg. level ten) on the game on a non-mobile device, when they install the game on a mobile device (eg. smartphone) they are already at the same level in the game when they start playing the game on the mobile device. They do not have to start at the lowest level for the game on the mobile device (eg. smartphone). A user may need to login to Facebook for the synchronization to occur. Also, the game appears exactly the same, or substantially the same, on the mobile device as on the non-mobile device.

Game features obtained in one platform may also be provided in other platforms. So for example if a game feature (eg. high precision in shooting to provide greater accuracy) has been purchased in one platform, that feature is also provided when the user downloads and plays the game on another platform. The feature is also provided if the user has already downloaded the game to a multiplicity of platforms, and then purchases the feature in one platform i.e. the feature is then provided in the multiplicity of platforms.

A game high score table, or a game table showing which level a user and each of his friends has reached, may be updated (e.g. in real time), so that the user can see his progress and the progress of his friends in the game, irrespective of which platform or platforms the user and his friends are playing the game on.

Facebook features may be integrated into the game. So for example a gift of a game feature can be sent to a friend using Facebook (eg. a Facebook controlled messaging system) to send the gift. A reply providing a gift back can be sent back by the friend. A Facebook pop-up screen may be provided when the game application is running on a mobile device.

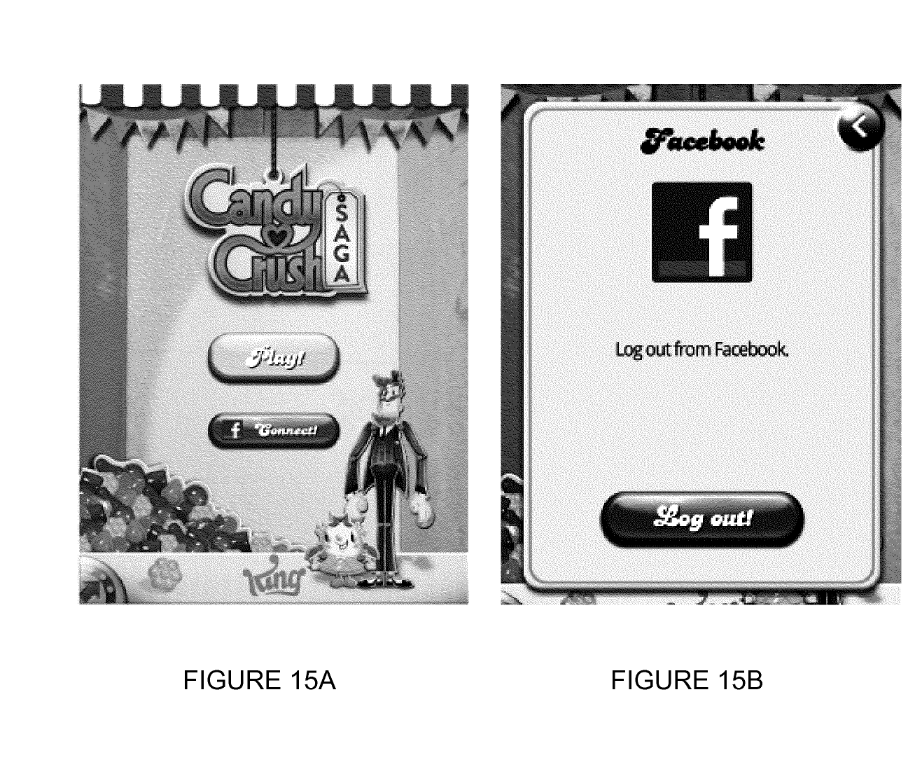

On a platform, the user may be offered the option before starting to play the game of whether or not to connect to Facebook. See FIG. 15A for example. On a platform, the user may be offered the option before starting to play the game of whether or not to log out from Facebook. See FIG. 15B for example. So if a player wants to play disconnected to Facebook, they can do so.

There are four possibilities to consider in a mobile game. Is the user connected to Facebook (Yes/No)? Does the user have a data connection (Yes/No)? Further possibilities include changes between the four possibilities eg. what happens if a user decides later to connect to Facebook, or if a data connection status changes from unavailable to available? For example, a user has played on a mobile for a while in a disconnected way, and the user has also made progress in the game on their personal computer which has a data connection, but they have made more progress in the game on their mobile device, and then they switch their mobile device from data not connected to data connected. What happens? The skilled person will understand that the solutions to these questions are disclosed in this document, because of the multi-platform game state synchronization.

For example, if a user is not connected to Facebook, and they run out of lives, they are offered the opportunity of connecting to Facebook, so that they can get more lives by inviting friends to the game on Facebook.

On a mobile device touch screen, there is provided in a game a “touch anywhere to shoot” function, so that touching anywhere on the screen will execute a function in a game, such as a shooting function.

The same icons in the game menu options may be used across all platforms on which the game is provided, in a multi-platform game.

An example of a platform in multi-platform gameplay system is a smart TV platform.

Functionality of a given platform is incorporated into the game for that platform. For example, a one click registration process (eg. via Facebook), invite your friends (eg. via Facebook), or ask your friends for help in the game, or offer to help your friends in the game, for example by sending them a gift of a feature in the game to help them in the game. For example, a “Like” button can be provided in a game in a Facebook platform.

There is provided a multi platform game, in which the game is launched with a number of levels, and then after launch further levels are developed and made available for players. This can be done, for example, if the game is popular. Alternatively, no levels are added after launch, for example if the game is unpopular. Progression between levels may be optimized after launch. For example, a minimum score to progress between levels can be adjusted post-launch. For example, the minimum score is raised if a level is too easy, or it is reduced if a level is too hard. If new levels are provided after launch, these may be provided by a new version of the game application available for download from the application store.

In a multi-platform game, the Facebook functionality may be standardized or modularized, so that the Facebook functionality can be used in a plurality of games programs with little or no modification.

In a multi-platform game, all user data is held in a standardized database that is valid across all game platforms.

In a multi-game multi-platform game system, all user data is held in a standardized database that is valid across all game platforms, and for all games.

In a mobile device platform, on a mobile device running a game an icon or user selectable option may be provided which if selected by a user initiates a synchronization process. An advantage is that a user can receive an up-to-date high score table or map. An advantage is that if data connectivity is intermittent, but a good data connection has arisen, a user may initiate a synchronization process to take advantage of the improved data connectivity.

Game state synchronization may be triggered by an event, such as by a user completing a level in a game. Game state synchronization may be pushed to a mobile device or to non-mobile device eg. from a server.

System for Enabling Interactive Gameplay

There is provided a system for enabling interactive gameplay, comprising:

a first server configured to communicate with a first computing device using a first Application Programming Interface (API), wherein the first server comprises a first data store;

a second server configured to communicate with a second computing device using a second API, wherein the second server comprises a second data store; and

a third server for communicating with the first server and second server, wherein the third server comprises a third data store;

wherein the first server, second server, and third server are configured to synchronize the first data store, second data store, and third data store to enable the first computing device and second computing device to engage in an interactive game.

There is provided a system for enabling interactive gameplay, comprising:

a first server configured to communicate with a first computing device using a first Application Programming Interface wherein the first server comprises a first data store;

a second server configured to communicate with a second computing device using a second API different to the first API, wherein the second server comprises a second data store; and

a third server for communicating with the first server and second server, wherein the third server comprises a third data store;

wherein the first server, second server, and third server are configured to synchronize the first data store, second data store, and third data store to enable the first computing device and second computing device to engage in an interactive game.

The system may be one wherein the first API is a facebook API.

The system may be one wherein the second API is an Android API.

The system may be one wherein the first API is a facebook API and the second API is an Android API.

The system may be one wherein the second API is an iOS API.

The system may be one wherein the first API is a facebook API and the second API is an iOS API.

The system may be one wherein the first computing device is a desktop computer.

The system may be one wherein the first computing device is a mobile device.

The system may be one wherein the third data store comprises a data structure for an interactive game.

The system may be one wherein the third data store comprises a data structure for an interactive game and wherein the data structure comprises information for a plurality of players in the game.

Method of Interactive Gameplay

There is provided a method of interactive gameplay, comprising:

displaying a game on a first computing device, wherein the first computing device comprises a first data store comprising a first data structure;

establishing communication between the first computing device and a first server using a first API, wherein the first server comprises a first server data store comprising a first server data structure;

displaying a game on a second computing device, wherein the second computing device comprises a second data store comprising a second data structure;

establishing communication between the second computing device and a second server using a second API, wherein the second server comprises a second server data store comprising a second server data structure;

synchronizing the first data structure and the first server data structure using the first API;

synchronizing the first server data structure and the second server data structure; and

synchronizing the second server data structure and the second data structure using the second API.

There is provided a method of interactive gameplay, comprising the steps of:

(i) displaying a game on a first computing device, wherein the first computing device comprises a first data store comprising a first data structure;

(ii) establishing communication between the first computing device and a first server using a first Application Programming Interface (API), wherein the first server comprises a first server data store comprising a first server data structure;

(iii) displaying a game on a second computing device, wherein the second computing device comprises a second data store comprising a second data structure different to the first data structure;

(iv) establishing communication between the second computing device and a second server using a second API different to the first API, wherein the second server comprises a second server data store comprising a second server data structure different to the first server data structure;

(v) synchronizing the first data structure and the first server data structure using the first API;

(vi) synchronizing the first server data structure and the second server data structure; and

(vii) synchronizing the second server data structure and the second data structure using the second API.

The method may be one wherein the first API is a facebook API.

The method may be one wherein the second API is an Android API.

The method may be one wherein the first API is a facebook API and wherein the second API is an Android API.

The method may be one wherein the second API is an iOS API.

The method may be one wherein the first API is a facebook API and wherein the second API is an iOS API.

The method may be one wherein the first computing device is a desktop computer.

The method may be one wherein the first computing device is a mobile device.

The method may be one wherein the step of synchronizing the first server data structure and the second server data structure is performed on a third server.

The method may be one wherein the step of synchronizing the first server data structure and the second server data structure is performed on a third server and wherein the third server comprises a master game data structure.

Note

It is to be understood that the above-referenced arrangements are only illustrative of the application for the principles of the present invention. Numerous modifications and alternative arrangements can be devised without departing from the spirit and scope of the present invention. While the present invention has been shown in the drawings and fully described above with particularity and detail in connection with what is presently deemed to be the most practical and preferred example(s) of the invention, it will be apparent to those of ordinary skill in the art that numerous modifications can be made without departing from the principles and concepts of the invention as set forth herein.

Concepts

There are multiple concepts, described as concepts ‘A-J’, in this disclosure. The following may be helpful in defining these concepts. Aspects of the concepts may be combined.

A. System for Enabling Interactive Gameplay

There is provided a system for enabling interactive gameplay, comprising:

a first server configured to communicate with a first computing device using a first Application Programming Interface (API), wherein the first server comprises a first data store;

a second server configured to communicate with a second computing device using a second API, wherein the second server comprises a second data store; and

a third server for communicating with the first server and second server, wherein the third server comprises a third data store;

wherein the first server, second server, and third server are configured to synchronize the first data store, second data store, and third data store to enable the first computing device and second computing device to engage in an interactive game.

The above may include additionally any of the following, alone or in combination:
the first API is a facebook API.
the second API is an Android API.
the second API is an Android API.
the second API is an iOS API.
the second API is an iOS API.
the first computing device is a desktop computer.
the first computing device is a mobile device.
the third data store comprises a data structure for an interactive game.
the data structure comprises information for a plurality of players in the game.
Any aspect according to concept C.
Use of any aspect of this concept.

B. A method of Interactive Gameplay

There is provided a method of interactive gameplay, comprising:

displaying a game on a first computing device, wherein the first computing device comprises a first data store comprising a first data structure;

establishing communication between the first computing device and a first server using a first Application Programming Interface (API), wherein the first server comprises a first server data store comprising a first server data structure;

displaying a game on a second computing device, wherein the second computing device comprises a second data store comprising a second data structure;

establishing communication between the second computing device and a second server using a second API, wherein the second server comprises a second server data store comprising a second server data structure;

synchronizing the first data structure and the first server data structure using the first API;

synchronizing the first server data structure and the second server data structure; and synchronizing the second server data structure and the second data structure using the second API.

The above may include additionally any of the following, alone or in combination:
the first API is a facebook API.
the second API is an Android API.
the second API is an Android API.
the second API is an iOS API.
the second API is an iOS API.
the first computing device is a desktop computer.
the first computing device is a mobile device.
the step of synchronizing the first server data structure and the second server data structure is performed on a third server.
the third server comprises a master game data structure.
Any aspect according to concept D.
Use of any aspect of this concept.

There is further provided a first computing device according to any aspect of concept B. There is further provided a second computing device according to any aspect of concept B.

C. Multiplayer Interactive Game Server System for Playing a Multiplayer Interactive Game

There is provided a multiplayer interactive game server system for playing a multiplayer interactive game, the system comprising:

a first server including a first data store relating to a state of the interactive game, the first server configured to communicate, using a first application programming interface, with a first plurality of devices of a first computing platform operable to participate in the interactive game;

a second server including a second data store relating to a state of the interactive game, the second server configured to communicate, using a second application programming interface different to the first application programming interface, with a second plurality of devices of a second computing platform, different to the first computing platform, operable to participate in the interactive game, and

a third server including a third data store relating to a state of the interactive game, the third server arranged to communicate with the first server and with the second server,

wherein the first, second and third servers are arranged to synchronize the first data store, the second data store and the third data store, such that when synchronized, the first data store, the second data store and the third data store all relate to a synchronized game state.

The above may include additionally any of the following, alone or in combination:
the third data store includes a data structure for the multiplayer interactive game.
the data structure includes information for a plurality of players in the game.
the first server is operable to create and store the first data store.
the first server is operable to create and store the first data store in response to a user of a device of the first plurality of devices requesting a new game to be created.
the first server is operable to create and store the first data store in response to a user of a device of the first plurality of devices requesting a new game to be created, including creating a new Game ID and data structure.
the first server is operable to create and store the first data store in response to a user of a device of the first plurality of devices requesting a new game to be created, comprising creating a new Game ID and data structure, the first server sending a message to the third server that the new Game ID and data structure has been created, the third server creating a corresponding data structure in response to the message, and populating the corresponding data structure.
the first data store comprises one or more tables in a database which can run on the first server.
the second server is operable to create and store the second data store.
the second server is operable to create and store the second data store in response to the user of the device of the first plurality of devices submitting a request to the first server to invite a user of a device of the second plurality of devices to the interactive game, the first server sending this request to the third server, the third server sending this request to the user of the device of the second plurality of devices, and the user of the device of the second plurality of devices accepting the request by sending an acceptance action to the second server.
the second data store comprises one or more tables in a database which can run on the second server.
the third server is operable to create and store the third data store.
the third data store includes a master game data store including the first data store and the second data store.
the third data store comprises one or more tables in a database which can run on the third server.
the first server is configured to update the first data store in response to a user of a device of the first plurality of devices progressing through the game.
the first server is configured to receive a synchronization request from a device of the first plurality of devices, the synchronization request including a timestamp, wherein the first server is configured to update the first data store with data from the synchronization request if the timestamp of the synchronization request is later than a timestamp of the first data store.
the first server is configured to send a synchronization request to the third server, the synchronization request including a timestamp, wherein the third server is configured to update the third data store with data from the synchronization request if the timestamp of the synchronization request is later than a timestamp of the third data store.
the third server is arranged to send data to the first server for updating the first data store in respect of data of other users of the multi-platform game, if the data of other users of the interactive game in the first data store and in the third data store do not match.
the second server is configured to update the second data store in response to a user of a device of the second plurality of devices progressing through the game.
the second server is configured to receive a synchronization request from a device of the second plurality of devices, the synchronization request including a timestamp, wherein the second server is configured to update the second data store with data from the synchronization request if the timestamp of the synchronization request is later than a timestamp of the second data store.
the second server is configured to send a synchronization request to the third server, the synchronization request including a timestamp, wherein the third server is configured to update the third data store with data from the synchronization request if the timestamp of the synchronization request is later than a timestamp of the third data store.
the third server is arranged to send data to the second server for updating the second data store in respect of data of other users of the multi-platform game, if the data of other users of the interactive game in the second data store and in the third data store do not match.
a user can play the interactive game even when a user does not have network connectivity.
a user can play the interactive game when a user does not have network connectivity, and in which a game state is synchronized after the user has regained network connectivity.
the system provides a connected fully-synchronized seamless experience for players of the interactive game.
the system provides an interactive game in which one, or more, or all, of the following are provided: the game is free for starters, the game is social, stop-start use is possible in the game, and seamless experience is provided in the game.
the system provides an interactive game in which the game can be played in a mobile environment and in a non-mobile environment.
the system provides an interactive game in which the game can be played online and offline.
the system provides an interactive game which includes a plurality of levels.
the system provides an interactive game which includes a plurality of levels, each of which runs for between 1 and 5 minutes.
the system provides an interactive game which includes a plurality of levels, in which a user can progress from a level to a next level by scoring a minimum score.
the system provides an interactive game which provides a screen which shows the level a user has reached and the levels reached by friends of the user in a social network.
the levels reached are indicated by corresponding places on a path on a map.
the position of a user or friend includes a representation which includes a photograph such as the user or friend's profile photo on Facebook.
the screen provides a list of level numbers achieved by the user and by friends of the user in the social network.
the screen is provided irrespective of which platform or platforms the user and his friends are playing the game on.
a user can invite a friend on a social network to join the interactive game, wherein the friend can receive the invite as a notification on his mobile device which is running a social network (eg. Facebook) application.
a selectable icon or selectable item is provided in the notification, wherein selecting the selectable icon or selectable item leads the friend to an application store for the mobile device, to a download page for the application, from where the friend can download the game application.
a user can invite a friend on a social network to join the interactive game, and the user receives new lives in the game if the friend joins the interactive game.
a user receives new lives in the interactive game if the user views a commercial or an advertisement.
a user can receive a life sent by a friend in a social network.
a user can purchase new lives in the game.
the interactive game is optimizable post launch through provision of an updated application in an application update, wherein the application update when installed does not change a synchronized state of the interactive game.
the interactive game is optimizable post launch through provision of an updated file of minimum scores required to progress through each level of the interactive game.
the interactive game is mobile-enabled, the system configured to send one or more of: notifications, news feed, time line and bookmarks to personal computers and to mobile devices.
any user who is a player of the interactive game on a social network on a non-mobile device, if they have a mobile device and they access the social network on that mobile device, then they will see in the social network on the mobile device a link to the game, which leads to the mobile device application store, to a screen from where the user can download the game for the mobile device.
any user who is a player of the interactive game on a social network on a non-mobile device, is provided with a “send to mobile” function in the social network on the non-mobile device, which is operable to send a download link for an interactive game application to a smartphone eg. using a text message service.
a user of a device of the first plurality of devices, when logging in to a social network on which the user is registered using a device in the second plurality of devices, is offered an opportunity to join the interactive game from the device in the second plurality of devices, wherein a game level of the user using the device of the first plurality of devices, and using the device of the second plurality of devices, is synchronized during a synchronization.
game features are synchronized during a synchronization.
a gift of a feature in the interactive game can be sent by a user to a friend in a social network.
a user can decide whether or not to connect to a social network before playing the interactive game.
if a user is not connected to a social network while playing the interactive game, and they run out of lives in the game, the user is offered the opportunity of connecting to the social network, so they can request more lives from their friends in the social network.
icons used across all platforms on which the game is provided are the same in each platform.
a platform is a smart TV platform.
functionality of a given platform is incorporated into the interactive game for that platform.
functionality includes a one click registration process in a social network platform.
functionality for a social network platform is coded in a standardized or modularized form for the interactive game, so that it may used in coding other interactive games, with little or no modification.
Use of any aspect of this concept.

D. Method of Synchronizing a State of a Multiplayer Interactive Game in a Multiplayer Interactive Game Server System

There is provided a method of synchronizing a state of a multiplayer interactive game in a multiplayer interactive game server system, the system comprising:

a first server including a first data store relating to a state of the interactive game, the first server configured to communicate, using a first application programming interface, with a first plurality of devices of a first computing platform operable to participate in the interactive game;

a second server including a second data store relating to a state of the interactive game, the second server configured to communicate, using a second application programming interface different to the first application programming interface, with a second plurality of devices of a second computing platform different to the first computing platform operable to participate in the interactive game, and

a third server including a third data store relating to a state of the interactive game, the third server arranged to communicate with the first server and with the second server, the method comprising the steps of:

(i) synchronizing the first data store on the first server with the third data store on the third server,

(ii) synchronizing the second data store on the second server with the third data store on the third server, and

(iii) synchronizing the first data store on the first server with the third data store on the third server,

such that when synchronized, the first data store, the second data store and the third data store all relate to a synchronized game state.

The above may include additionally any of the following, alone or in combination:
the third data store includes a data structure for the multiplayer interactive game.
the data structure includes information for a plurality of players in the game.
Any of the above aspects when applied to a system according to any aspect of concept C.
Use of any aspect of this concept.

E. Device

There is provided a device, the device being in the first plurality of devices of a system according to any aspect of concept C, the device configured to communicate with the first server, the device including an application operable to run the interactive game on the device, wherein the application is configured to create and to store on the device a data structure for a user of the device relating to a state of the interactive game.

The above may include additionally any of the following, alone or in combination:
the data structure on the device includes one or more tables in a database.
the data structure on the device includes one or more tables in a database which can run on the device.
the device is operable to initiate the interactive game by sending a message to the first server, the device then creating the data structure on the device.
the device further operable to receive from the first data server data relating to a synchronized game state, and to store the data in the data structure on the device.
the device is operable to send a request to the first server to invite a user of a device of the second plurality of devices to join the interactive game.
the device is operable to send a request to the first server to invite a user of a device of the second plurality of devices to join the interactive game, and in response to the user of the device of the second plurality of devices joining the interactive game the device is configured to receive from the first data server data relating to a synchronized game state, and to store the data in the data structure on the device.
the device is configured to update the data structure on the device in response to a user playing the game on the device progressing through the interactive game.
the device is configured to update the data structure on the device in response to a user playing the game on the device progressing through the interactive game even when the device is not in connection with the first server.
the device is configured to send a synchronization request to the first server, the synchronization request including the current state of progress of a user of the device in the interactive game, and a timestamp.
the device is configured to receive updated data relating to other players of the game from the first server, in response to the synchronization request, and to store the updated data in the data structure.
the device is a mobile device, wherein the device displays an icon or user selectable option which if selected by a user initiates a synchronization process.
the device is configured to automatically initiate a synchronization process in response to occurrence of a predefined event.
the event is completion of a level in a game by a user.

There is further provided a computer program product embodied on a non-transient storage medium, the computer program product operable to execute on a device in the first plurality of devices of a system according to any aspect of concept C, the device configured to communicate with the first server, the computer program product when running on the device providing the interactive game on the device, wherein the computer program product is configured to create and to store on the device a data structure for a user of the device relating to a state of the interactive game.

F. Multiplayer Multiple Interactive Game Server System

There is provided a multiplayer multiple interactive game server system comprising:

a first server including a first data store relating to states of a plurality of interactive games, the first server configured to communicate, using a first application programming interface, with a first plurality of devices of a first computing platform operable to participate in the plurality of interactive games;

a second server including a second data store relating to states of a plurality of interactive games, the second server configured to communicate, using a second application programming interface different to the first application programming interface, with a second plurality of devices of a second computing platform different to the first computing platform operable to participate in the plurality of interactive games, and a third server including a third data store relating to states of the plurality of interactive games, the third server arranged to communicate with the first server and with the second server,

wherein the first, second and third servers are arranged to synchronize the first data store, the second data store and the third data store, such that when synchronized, the first data store, the second data store and the third data store all relate to synchronized states of the plurality of interactive games.

The above may include additionally any of the following, alone or in combination:
any aspect of concept C.

G. Method of Synchronizing a State of a Plurality of Multiplayer Interactive Games in a Multiplayer Multiple Interactive Game Server System

There is provided a method of synchronizing a state of a plurality of multiplayer interactive games in a multiplayer multiple interactive game server system comprising:

a first server including a first data store relating to states of the plurality of interactive games, the first server configured to communicate, using a first application programming interface, with a first plurality of devices of a first computing platform operable to participate in the plurality of interactive games;

a second server including a second data store relating to states of the plurality of interactive games, the second server configured to communicate, using a second application programming interface different to the first application programming interface, with a second plurality of devices of a second computing platform different to the first computing platform operable to participate in the plurality of interactive games, and

a third server including a third data store relating to states of the plurality of interactive games, the third server arranged to communicate with the first server and with the second server, the method comprising the steps of:

(i) synchronizing the first data store on the first server with the third data store on the third server,

(ii) synchronizing the second data store on the second server with the third data store on the third server, and

(iii) synchronizing the first data store on the first server with the third data store on the third server,

such that when synchronized, the first data store, the second data store and the third data store all relate to synchronized states of the plurality of interactive games.

The above may include additionally any of the following, alone or in combination:
any aspect of concepts C or D.

H. A First Server

There is provided a first server according to any aspect of concepts A, B, C or D. Use of such a server may be provided.

I. A Second Server

There is provided a second server according to any aspect of concepts A, B, C or D. Use of such a server may be provided.

J. A Third Server

There is provided a third server according to any aspect of concepts A, C or D. Use of such a server may be provided.

Note

It is to be understood that the above-referenced arrangements are only illustrative of the application for the principles of the present invention. Numerous modifications and alternative arrangements can be devised without departing from the spirit and scope of the present invention. While the present invention has been shown in the drawings and fully described above with particularity and detail in connection with what is presently deemed to be the most practical and preferred example(s) of the invention, it will be apparent to those of ordinary skill in the art that numerous modifications can be made without departing from the principles and concepts of the invention as set forth herein.

1-107. (canceled)

108. A computer implemented method of interactive gameplay comprising:
accessing a social network site using a login for a user on a first user device;
receiving a link for a game played by said user on a different user device; and
using said link to download said game to said first user device.

109. The method of claim 108, displaying said link on a display of said first user device.

110. The computer implemented method of claim 108, further comprising:
synchronising game progress of the game on the first user device with the game progress of the game on the different user device.

111. The computer implemented method of claim 110, storing game information in at least one field of a data structure of a data store of said user device, said data structure comprising a status of game progress field.

112. The computer implemented method of claim 110, wherein synchronising comprises receiving game progress information from a server.

113. A user device for enabling interactive gameplay configured to:
access a social network site using a login for a user on a first user device;
receive a link for a game played by said user on a different user device; and
use said link to download said game to said first user device.

114. The user device of claim 113, comprising a display, wherein said user device is configured to display said link on the display.

115. The user device of claim 113, wherein the user device is configured to synchronising game progress of the game on the user device with the game progress of the game on the different user device.

116. The user device of claim 115, comprising a data store configured to store game information in at least one field of a data structure of the data store, said data structure comprising a status of game progress field.

117. The user device of claim 115, wherein the user device is configured to receive game progress information from a server for synchronising of said game progress.

118. A computer implemented method of interactive gameplay comprising:
running an interactive game for a first user of said interactive game on a first user device;
receiving game data, wherein said game data comprises at least one user identity of at least one other user of said interactive game and at least one game progress field associated with said at least one other user of said interactive game; and
displaying on a display of said first user device game progress of said at least one other user of said interactive game.

119. The method of claim 118, further comprising:
receiving a further at least one game progress field of said another user; and
overwriting the at least one game progress field of said at least one other user with the further at least on game progress field of said at least one other user if there is a mismatch between the at least one game progress field of said at least one other user with the further at least one game progress field of said at least one other user.

120. The method of claim 118, wherein said game data relates to at least one user from said first user's list of contacts on a social networking site.

121. A user device for enabling interactive gameplay configured to:
run an interactive game for a first user of said interactive game;
receive game data, wherein said game data comprises at least one user identity of at least one other user of said interactive game and at least one game progress field of said at least one other user of said interactive game; and
display on a display information about game progress of said at least one other user of said interactive game.

122. The user device as claimed in claim 121, comprising a data store, said data store configured to store in a data structure said game data.

123. The user device of claim 121, further configured to:
receive updated game data comprising an updated game progress field of said another user; and
updating the game data in said data structure.

124. The user device of claim 123, wherein said game data comprises a time stamp and said user device is configured to update said game data if said timestamp is later than the time stamp of previous game data.

125. The user device of claim 121, wherein said game data relates to at least one user from a list of list of contacts on a social networking site associated with a user of said user device.

126. The user device of claim 121, wherein said user device is configured to display on said display game progress of said at least one other user of said interactive game and game progress of said first user.

127. A computer implemented method of interactive gameplay comprising:
running an interactive game for a first user of said interactive game;
receiving game data, wherein said game data comprises at least one user identity of at least one other user of said interactive game and at least one game progress field of said at least one other user of said interactive game; and
displaying on a display information about game progress of said at least one other user of said interactive game.

128. The computer implemented method as claimed in claim 127, comprising storing said game data in a data structure of said store.

129. The computer implemented method of claim 127, further configured to:
receiving updated game data comprising an updated game progress field of said another user; and
updating the game data in said data structure.

130. The computer implemented method of claim 129, wherein said game data comprises a time stamp and said method comprises updating said game data if said timestamp is later than the time stamp of previous game data.

131. The computer implemented method of claim 127, wherein said game data relates to at least one user from a list of list of contacts on a social networking site associated with said first user.

132. The computer implemented method of claim 127, wherein said user device is configured to display on said display game progress of said at least one other user of said interactive game and game progress of said first user.
